(19) United States
(12) Patent Application Publication
(10) Pub. No.: US 2016/0104922 A1
(43) Pub. Date: Apr. 14, 2016

(54) Cooling Device, Particularly for Battery Modules, and Vehicle Comprising Such a Cooling Device

(71) Applicant: Bayerische Motoren Werke Aktiengesellschaft, Muenchen (DE)

(72) Inventors: Thomas HOEFLER, Groebenzell (DE); Sebastian Siering, Muenchen (DE); Fabian Burkart, Muenchen (DE); Tuncay Idikurt, Muenchen (DE); Florian Landerer, Grafing (DE)

(21) Appl. No.: 14/799,164

(22) Filed: Jul. 14, 2015

Related U.S. Application Data
(63) Continuation of application No. PCT/EP2013/075524, filed on Dec. 4, 2013.

(30) Foreign Application Priority Data
Jan. 15, 2013 (DE) 10 2013 200 448.6

(51) Int. Cl. H01M 10/613; H01M 10/6556; H01M 2/10; B60L 11/18; F28D 15/00

(52) U.S. Cl. CPC H01M 10/613; B60L 11/1874; F28D 15/00; H01M 2/1083; H01M 10/6556; F28F 2275/00

(57) ABSTRACT

The invention relates to a cooling device, particularly for a battery, comprising a cooling element that can be connected to an object to be cooled, a first cooling connector that is connected to the cooling element, and a second cooling connector that can be supported on a mounting plate, the first cooling connector and the second cooling connector being connectable such that a transfer of a cooling fluid is possible from the first cooling connector to the second cooling connector.

### CROSS REFERENCE TO RELATED APPLICATIONS

This application is a continuation of PCT International Application No. PCT/EP2013/075524, filed Dec. 4, 2013, which claims priority under 35 U.S.C. §119 from German Patent Application No. 10 2013 200 448.6, filed Jan. 15, 2013, the entire disclosures of which are herein expressly incorporated by reference.

### BACKGROUND AND SUMMARY OF THE INVENTION

The present invention relates to a cooling device for objects to be cooled, particularly for battery modules. The invention further relates to an automobile in which such a cooling device is present and is preferably used to cool battery modules.

Particularly in electric or hybrid vehicles, battery cells are used which usually require cooling. This can be achieved by means of air or liquid media such as direct cooling media or water/glycol mixtures, for example. In order to enable easy mounting and exchanging in case of servicing, when cooling with liquid media, particularly with cooling media, the cooler is usually mechanically braced and contacted only with the battery cells. In the case of a purely mechanical connection of the cooler to the battery cells, however, the cooling performance that can be achieved is poorer than with cohesive connections due to the additional thermal resistance of the dividing medium between cooler and battery cells. The cohesive connection also has the drawback that, in the case of servicing, the entire unit of cooler and battery cells has to be exchanged. Moreover, it is expedient to use cooler units that are as small as possible so that small exchangeable units are created. This, in turn, has the drawback that many hydraulic connection points are required, which involves a risk in terms of tightness. The effort required for assembly also increases with every connection point.

For the sake of example, the arrangement of battery cell and cooler of printed publication DE 10 2010 056 261 A1 is shown. Batteries and cooling plates are constructed in layers so that, in the event of the removal of a single battery, the entire cooling system must also be removed. Another example is known from DE 10 2009 006 990 A1. Here, a cooling device is introduced into the mounting place to which the battery is attached. The cooling device comprises cooling ribs on the side of the mounting plate facing away from the battery and, on the other hand, cooling channels through which a cooling fluid flows and which are disposed in the mounting plate. However, this arrangement has the abovementioned drawback that the batter is merely pressed mechanically onto the mounting place. This results in unfavorable heat transfer between mounting plate and battery, since an air gap always remains here between cooler and battery. It is the object of the present invention to provide a cooling device that is simple and cost-effective to manufacture while enabling good cooling performance for objects, particularly battery modules, and simple assembly and maintenance. It is also the object of the invention to provide an automobile having batteries that are cooled with such a cooling device.

The object is thus achieved by a cooling device having a cooling element, the cooling element being connectable to an object to be cooled. The object to be cooled can particularly be a battery. Moreover, the cooling device according to the invention comprises a first cooling connector that is connected to the cooling element and a second cooling connector that can be supported on a mounting plate. In this context, a “mounting plate” is understood as being a support structure, a housing component or an intermediate floor, for example. The mounting plate is embodied such that a plurality of objects to be cooled can be mounted on it together with a corresponding plurality of cooling devices according to the invention. Moreover, a provision is made according to the invention that the first cooling connector and the second cooling connector can be connected such that passage of a cooling fluid from the first cooling connector to the second cooling connector is possible. The cooling fluid can be a direct cooling medium or a water/glycol mixture, for example, or a gas or a two-phase mixture and is preferably used to absorb heat from the object in the cooling element and dissipate this heat. As a result, the invention makes it possible in an advantageous manner to construct a cooling system such that the cooling device according to the invention enables connection of an object to be cooled with the first cooling connector, and a connection to a distribution network and/or to another cooling connector and hence another object to be cooled is made possible with the second cooling connector. The connection between first cooling connector and second cooling connector thus constitutes the interface between distribution system and heat absorption site for the cooling fluid.

Moreover, the object is achieved by an automobile comprising at least one energy store, for example a battery module. In addition, the automobile has a cooling device according to the invention that is designed to cool the energy store.

The sub-claims show preferred developments of the invention.

Preferably, a provision is made that the first cooling connector and the second cooling connector establish a self-centering connection. For example, this can be done by means of a conical opening and/or a conical trunnion guided in each other. Another embodiment provides for wedge-shaped and/or angular surfaces on one or more fluid connectors in the cooling device according to the invention, for example. This enables simpler tolerance compensation and simpler positioning during the assembly of the cooling device on the mounting plate. This is done, for example, by lining up the cooling devices in a stepwise manner during assembly. As a result of the stepwise lining-up, no additional tolerance compensation elements are required between the individual cooling devices. Alternatively or in addition, a provision is preferably made that the connection between the first cooling connector and the second cooling connector is embodied such that a positional tolerance and/or an angular tolerance in the alignment of the cooling connectors with respect to each other is compensated for. This can also be achieved, for example, by means of a connection in the manner of a ball-and-socket joint. Overall, as a result of the connection between first cooling connector and second cooling connector, the overall tolerance compensation is performed during connection of the object to be cooled to a cooling circuit, so additional tolerance compensation elements are no longer needed.

In another preferred development of the invention, attachment of the cooling device to the mounting plate is achieved by a mounting means. A provision is preferably provided that the same mounting means also fixes a connection between first cooling connector and second cooling connector. By virtue of this development, assembly and disassembly of the object on or from the mounting plate is advantageously facilitated because, upon detachment of the connection between mounting plate and object, the cooling elements are also detached. On the other hand, a firm connection between mounting plate and object is also advantageously used to ensure a firm connection between first cooling connector and second cooling connector. This ensures good tightness of the entire cooling system. Especially preferably, a further provision is made that the mounting means is a positive-fitting mounting means. For example, it can involve screwing or clipping or clamping or riveting. A positive-fitting mounting means enables simple and cost-effective assembly of the object, the first cooling connector and the second cooling connector on the mounting plate while ensuring a likewise simple and cost-effective disassembly of the components.

Advantageously, the connection between object and cooling element is positive-fitting and/or cohesive. In the case of a cohesive connection, for example, an adhesive with good thermal conductivity can be used. Object and cooling element thus preferably form a unit and are also preferably mounted jointly on the mounting plate.

Moreover, a provision is made that a sealing element is arranged between cooling connector and cooling element. Through the sealing element, the connection point is sealed off so as to prevent leakage of a cooling medium. The tightness of the entire cooling system is thus increased.

In order to construct a cooling system, several cooling elements must be connected to one another. For this reason, the second cooling connector according to the invention is advantageously embodied such that it can be connected to two first cooling connectors. In this way, it is possible to implement series connections and parallel connections of several cooling elements and thus objects to be cooled. The cooling device according to the invention can therefore preferably be used as part of a cooling system that comprises both individual and a plurality of cooling elements connected to one another. The cooling elements are connected using first cooling connectors and second cooling connectors according to the invention and second cooling connectors of this preferred embodiment.

Especially preferably, the second cooling connector is embodied in a single part, so that only one component is needed in order to connect two first cooling connectors. Alternatively, the second cooling connector can advantageously have at least two connecting parts that are preferably connected via a transfer element. For improved tolerance compensation, this can be embodied, for example, as an omega line, i.e., a line structured in an omega shape. With such a construction, the second cooling connector can be produced cost-effectively and quickly but nonetheless enables a secure connection of two first cooling connectors. Also advantageously, it is possible to combine the two alternatives. In that case, the second cooling connector is embodied in a single part and comprises two connecting parts and one transfer element.

In another advantageous embodiment, both the first cooling connector and the second cooling connector have a chamfered surface. The surfaces are particularly chamfered toward the mounting plate and/or the cooling element and are preferably aligned such that the chamfered surface of the first cooling connector and the chamfered surface of the second cooling connector are arranged parallel to each other when a connection is established between the two cooling connectors. A self-centering effect is thus achieved during assembly. The chamfered surfaces each have an opening through which the cooling fluid can be transferred from the first cooling connector to the second cooling connector and vice versa.

In order to establish a secure connection between first cooling connector and second cooling connector, a provision is advantageously made that the second cooling connector is embodied as a holder. The second cooling connector can thus receive the first cooling connector and simultaneously enable the transfer of cooling fluid. Consequently, no additional receiver need be provided for the cooling element in this advantageous embodiment, since the cooling element is already supported by the connection between first cooling connector and second cooling connector.

Finally, a provision is preferably made that one of the two cooling connectors, particularly the first cooling connector, has an opening, whereas the other cooling connector, particularly the second cooling connector, has a trunnion. The trunnion is preferably conical at least in part and can preferably be inserted into the opening of the first cooling connector. Advantageously, a further provision is made that the transfer of cooling fluid from the first cooling connector to the second cooling connector and vice versa is possible via the trunnion and via the opening. For example, the trunnion can have a through-hole arranged in the longitudinal direction of the trunnion that transfers the cooling fluid. According to the invention, this also applies to angular or wedge-shaped cooling connectors.

If a second cooling connector is not provided for the connection of at least two first cooling connectors, but one first cooling connector with another component of a cooling circuit—for instance, with a storage arrangement or a heat exchanger for the cooling fluid—then the second cooling connector preferably has at least one connection area for a casing of the other component.

Additional details, features and advantages of the invention follow from the following description and the figures.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic view of a cooling device according to a first preferred exemplary embodiment of the invention in an exploded view;

FIG. 2 shows a schematic view of an object that is to be cooled using the cooling device according to the first exemplary embodiment of the invention;

FIG. 3 shows a schematic view of the assembled cooling device according to the first preferred exemplary embodiment of the invention;

FIG. 4 shows a schematic view of several objects that are to be cooled using the cooling device according to the first exemplary embodiment of the invention;

FIG. 5 shows a schematic view of a cooling device according to a second preferred exemplary embodiment of the invention, particularly the cooling connector;

FIG. 6 shows a schematic view of several objects that are to be cooled using the cooling device according to the second exemplary embodiment of the invention;

FIG. 7 shows a schematic view of a cooling device according to a third preferred exemplary embodiment of the invention;

FIG. 8 (a) shows a schematic view of a section of the cooling device according to the third preferred exemplary embodiment of the invention; and

FIGS. 8 (b) to 8 (i) show alternative embodiments of the section of the cooling device according to the invention shown in FIG. 8 (a).

### DETAILED DESCRIPTION OF THE DRAWINGS

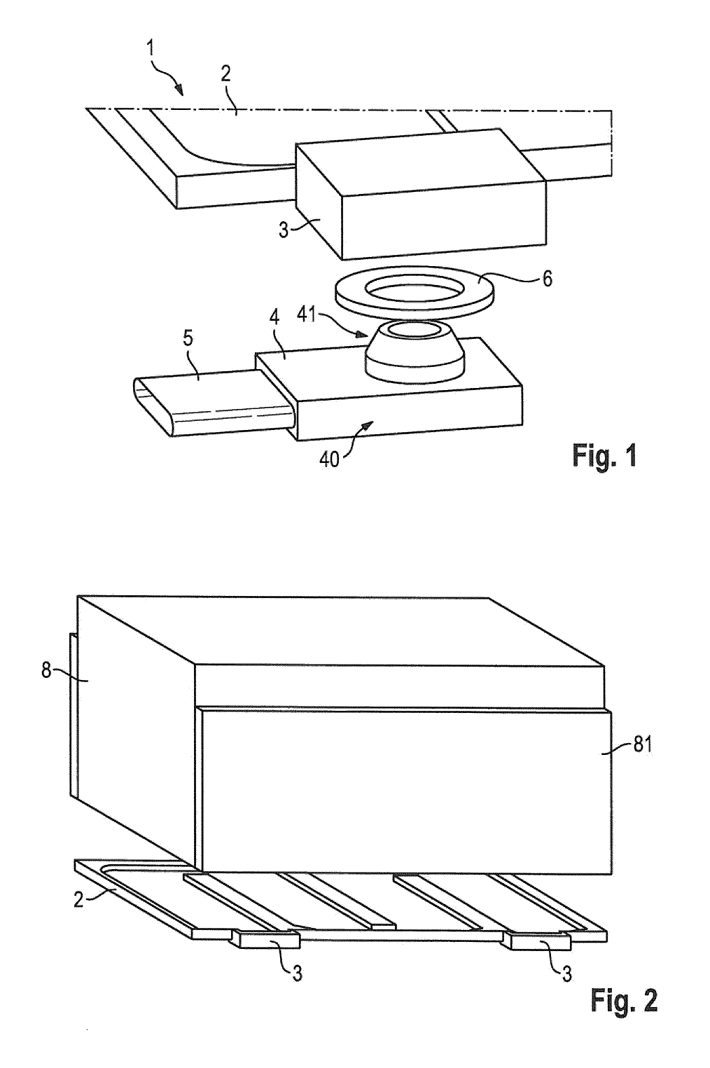

FIG. 1 shows a schematic view of a first exemplary embodiment of the cooling device 1 according to the invention. The cooling device 1 comprises a cooling element 2, which can be embodied as a plate, for example. The cooling element 2 serves to absorb and dissipate heat of an object 8 connected to the cooling element 2 (cf. FIG. 2). Moreover, the cooling element 2 is connected to a first cooling connector 3, which constitutes an interface for discharging and/or supplying a cooling fluid. For this purpose, the first cooling connector 3 has an opening in which a trunnion 41 of a second cooling connector 4 can engage. The trunnion 41 is arranged on a connecting part 40 of the second cooling connector 4 and enables transfer of the cooling fluid from the first cooling connector 3 to the second cooling connector 4. The cooling fluid can be a direct cooling medium or a water/glycol mixture, for example. In order to prevent the cooling fluid from leaking from the connection between the first cooling connector 3 and the second cooling connector 4, a sealing element 6 is present which is embodied as a sealing ring, for example.

The second cooling connector 4 further comprises a transfer element 5 with which the cooling fluid can be transferred from the connecting part 40 of the second cooling connector 4 to another connecting part 40. The transfer element 5 can be a pipe with a round or oval cross section, for example. This renders manufacture and assembly within the connecting part 40 very easy.

The cooling device 1 according to the invention thus makes it possible to connect two cooling elements 2 to each other by mounting a respective first cooling connector 3 on each cooling element 2 and connecting each of the first cooling connectors 3 by means of a second cooling connector to at least two connecting parts 40. In this way, it is possible to construct a complex cooling system, for example.

The use of the cooling device according to the invention is explained in FIGS. 2 to 4.

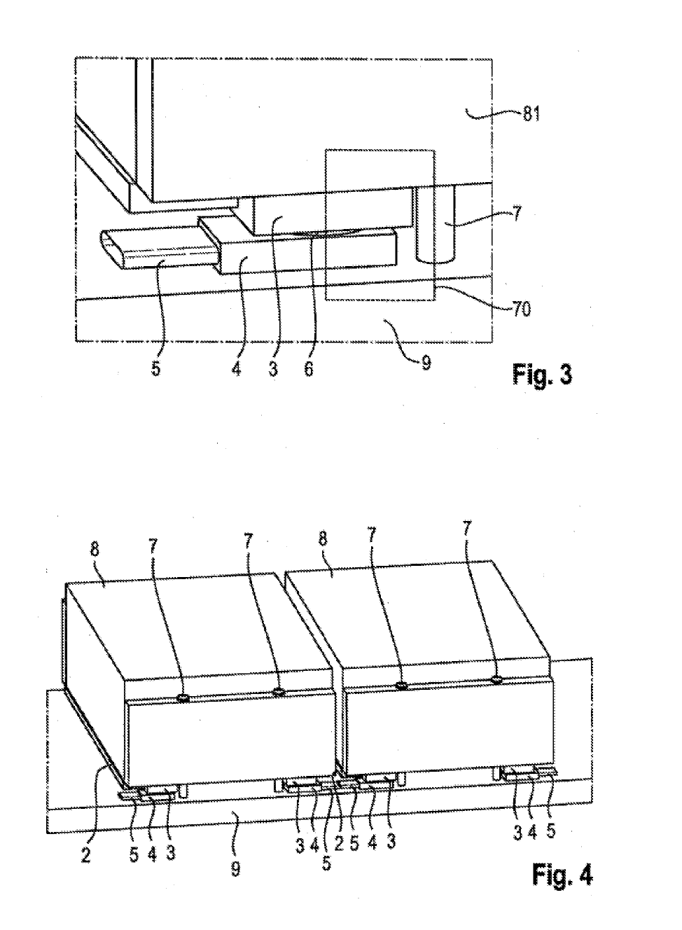

FIG. 2 shows a schematic view of an object 8 to be cooled, which can be a battery cell, for example. The object 8 is mounted on the cooling element 2, with a thermally conductive adhesive preferably being used for the connection between object 8 and cooling element 2. However, other types of attachment are also possible, such as a positive-fitting connection, for example. Two first cooling connectors 3 are disposed on the cooling element 2 that serve to supply the cooling element 2 with a cooling fluid and to dispose of the cooling fluid. Moreover, the object 8 has a mounting area 81 that is used for attaching the object to a mounting plate 9 (see FIG. 3).

FIG. 3 shows the connection of one of the first cooling connectors 3 of the cooling element 2 from FIG. 2 to a second cooling connector 4. The fixation of the connection between first cooling connector 3 and second cooling connector 4 is done using a mounting means 7, which can be a screw, for example, the mounting means 7 also attaching the mounting area 81 of the object 8 to the mounting plate 9. This results in the force-fit 70, which enables secure pressing of the first cooling connector 3 against the second cooling connector 4 and hence a tight connection between the first cooling connector 3 and the second cooling connector 4.

A cooling fluid can now be fed via the transfer element 5, the cooling fluid being delivered from the second cooling connector 4 to the first cooling connector 3, thus reaching the cooling element 2. Likewise, the cooling fluid can be discharged from the cooling element 2 via the first cooling connector 3 to the second cooling connector 4, so that the cooling fluid is discharged from the transfer element 5.

FIG. 4 shows a combination of two cooling elements 2. Here, two cooling elements 2, each of which cools an object 8, are to be connected to one another such that a cooling fluid can be exchanged between the two cooling elements 2. This exchange occurs via the connection between first cooling connector 3 and second cooling connector 4 described in FIG. 3, two connecting parts 40 being arranged on the transfer element 5.

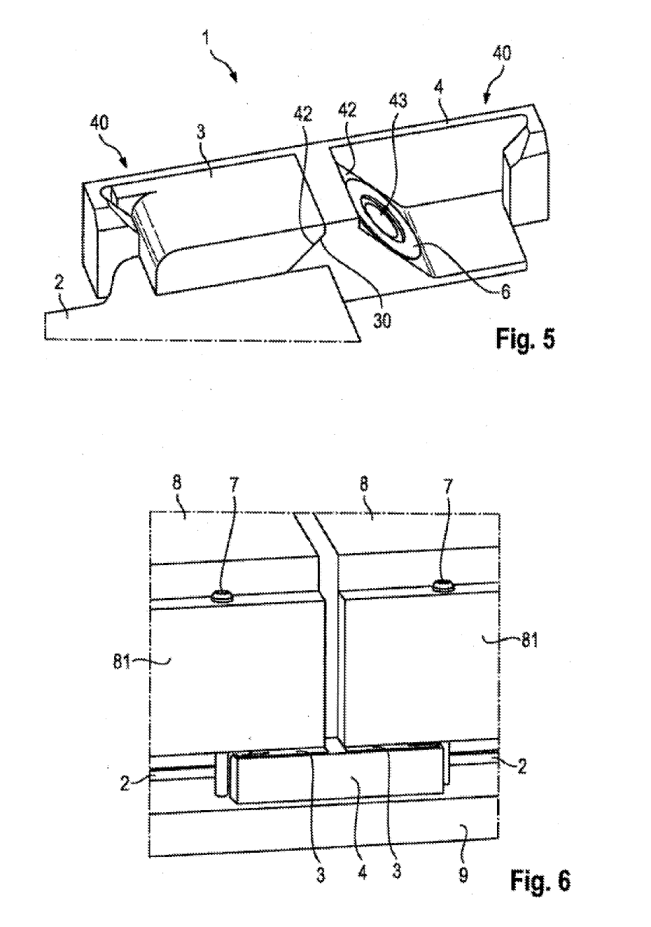

FIG. 5 shows the cooling device 1 with an exemplary view obliquely from below according to a second exemplary embodiment of the invention. Here, the second cooling connector 4 has two connecting parts 40 that are integrally connected with one another. Each of the connecting parts 40 comprises a surface 42 that is chamfered toward the cooling element 2 and toward the mounting plate 9 (see FIG. 6). An opening 43 is provided within the chamfered surface 42 that is round, for example.

Moreover, the second cooling connector 4 is embodied as a holder and enables the first cooling connector 3 to be received. The first cooling connector 3 also has a chamfered surface 30 having the same angle with respect to the mounting plate 5 (see FIG. 6) and to the cooling element 2, just like a corresponding chamfered surface 42 of the second cooling connector. The chamfered surface 30 of the first cooling connector 3 and the chamfered surface 42 of the second cooling connector 4 are thus arranged parallel to one another. The chamfered surface 30 of the first cooling connector 3 contains an opening (not visible in FIG. 5) that is disposed so as to fit with the opening 43 of the chamfered surface 42 of the second cooling connector 4. An exchange of the cooling fluid between first cooling connector 3 and second cooling connector 4 is possible through the two openings. As a result, the second cooling connector 4 connects two first cooling connectors 3 to one another, whereas the first cooling connector 3 is connected to the cooling element 2. In order to seal off the connection, a sealing element 6, for example a sealing ring, is also inserted between first cooling connector 3 and second cooling connector 4. The function of the individual components is thus identical to that of the first exemplary embodiment.

Finally, FIG. 6 shows a combination of two cooling elements 2, each of which cools an object 8. The fundamental construction is identical to that of the first exemplary embodiment shown in FIG. 4, except that the first cooling connector 3 and the second cooling connector 4 are different. The second cooling connector 4 is embodied as a holder, particularly as a kind of clamp or connecting bridge, and receives two first cooling connectors 3. Through the receiving of the two first cooling connectors 3, a self-centering connection is achieved between first cooling connector 3 and second cooling connector 4, since the chamfered surfaces 30 of the first cooling connector 3 and the chamfered surfaces 42 of the second cooling connector 4 are aligned relative to each other. This results in tolerance compensation during the connection of the first cooling connector 3 and second cooling connector 4 in the overall structure. Moreover, analogously to the first exemplary embodiment, the cooling fluid is transported via this connection between the cooling elements 2 in order to produce a cooling circuit.

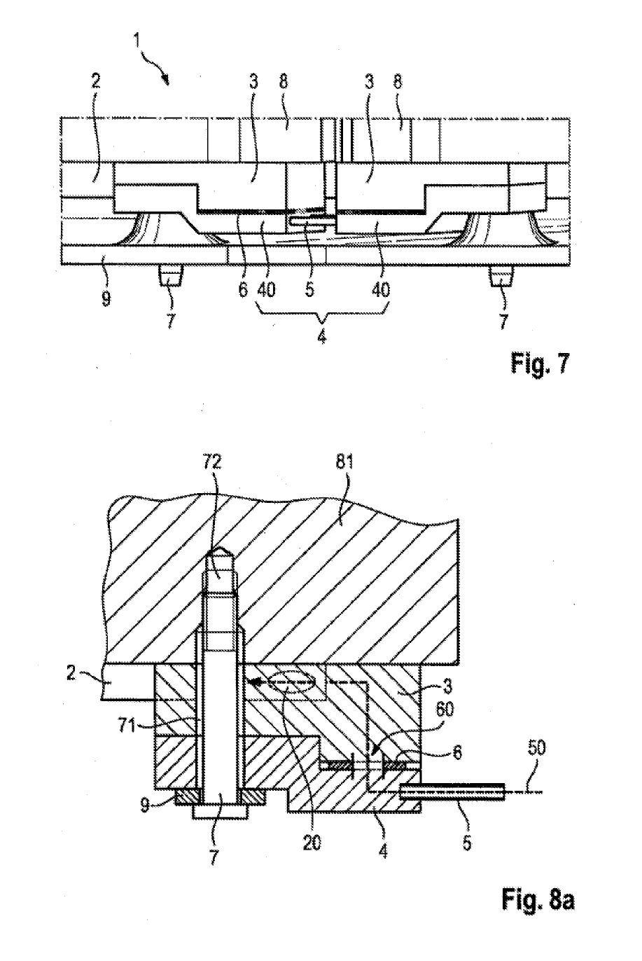

FIG. 7 shows a schematic view of the cooling device according to a third exemplary embodiment of the invention. Objects 8, for example battery modules, are mounted on the mounting plate 9, the objects 8 being connected cohesively with a respective cooling element 2. The cooling elements 2 are located on the underside of the objects 8 and can thus cool the objects 8. In order to achieve a closed cooling circuit, two first cooling connectors 3 and one second cooling connector 4 are present with which two cooling elements 2 are connected. The second cooling connector 4 comprises two connecting parts 40 that are connected via the transfer element 5.

The second cooling connector 4 establishes a connection to the cooling elements 2 via the connecting parts 40 and the first cooling connectors 3, so that the cooling fluid can be transferred between the cooling elements 2. In this way, the first cooling connector 3 and the second cooling connector 4 make it possible to distribute the cooling fluid, preferably in a circuit, to different cooling elements 2.

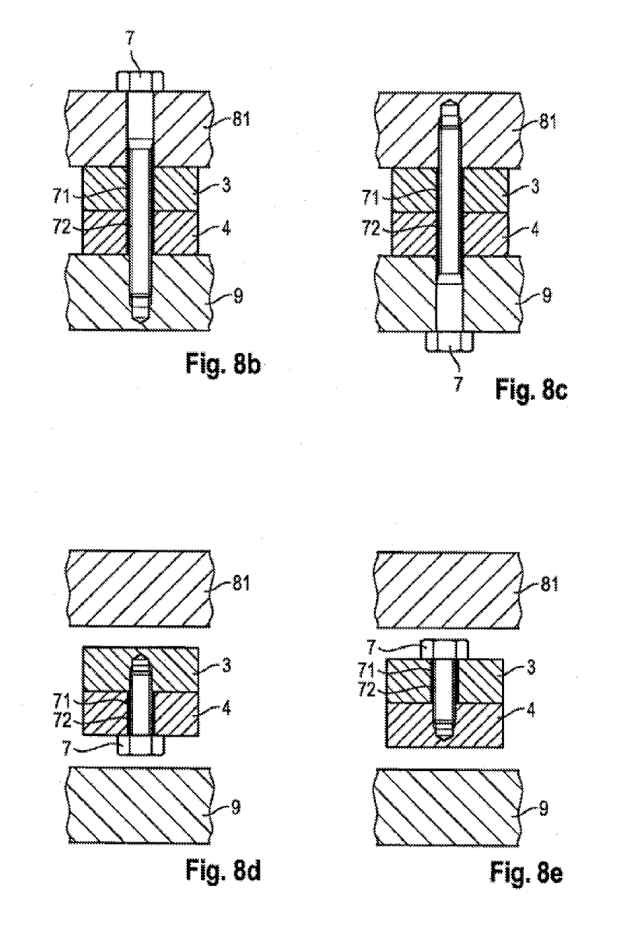

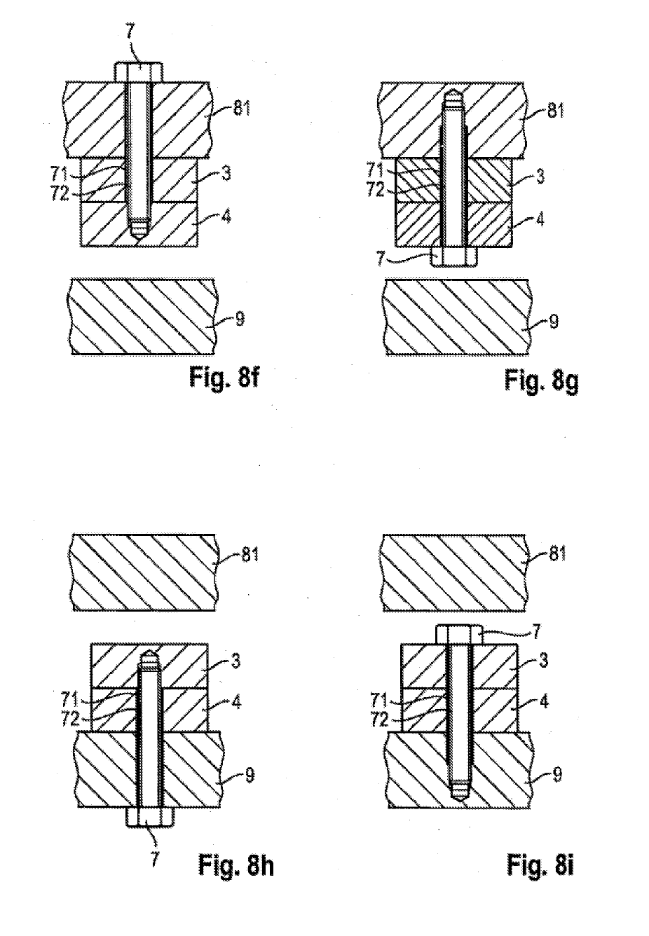

FIG. 8 (a) shows a schematic view of a section from the cooling device 1 according to the third exemplary embodiment of the invention. The section shows the cooling element 2, the first cooling connector 3 and the second cooling connector 4. The first cooling connector 3 is connected to the cooling element 2, the cooling fluid being transferable via an opening 20 from the cooling element 2 to the first cooling connector 3. Likewise, an opening 60 is provided between the first cooling connector 3 and the second cooling connector 4 via which a cooling fluid can be transferred. In order to seal off this transfer, the cooling device 1 has a sealing element 6 arranged between first cooling connector 3 and second cooling connector 4. Overall, a transfer path 50 can thus be implemented via which a fluid supplied via the transfer element 5 is conducted into the cooling element 2.

To connect the first cooling connector to the second cooling connector 4, both first cooling connector 3 and second cooling connector 4 have a through-hole 71. The mounting means 7 can be passed through this through-hole 71. The mounting means 7 provides for the connection between the connecting area 81 of the object 8 and mounting plate 9, for example by screwing the mounting means 7, embodied as a screw, into a thread 72 of the connecting area 81. As a result of this connection, the first cooling connector 3 and the second cooling connector 4 are pressed together simultaneously. As a result, the cooling device 1 according to the invention enables both simple assembly and simple disassembly. Nonetheless, as a result of the pressing-together of first cooling connector 3 and second cooling connector 4 and the additional use of the seal 6, a tight cooling device 1 is produced with which the objects 8 can be cooled safely and reliably.

An alternative connection is shown in FIG. 8 (b). Here, the mounting means 7 fixes the connecting area 81 of the object 8 and the mounting plate 9 as well as the first cooling connector 3 and the second cooling connector 4 by means of a thread (72) in the mounting plate 9. FIG. 8 (c) shows a similar construction, but here, unlike in FIG. 8 (b), a thread 72 is present in the connecting area 81 of the object 8 and not in the mounting plate 9.

Another alternative connection is shown in FIG. 8 (d). Here, the mounting means 7 fixes the first cooling connector 3 and the second cooling connector 4 by means of a thread 72 in the first cooling connector 3. FIG. 8 (e) shows a similar construction, but here, unlike in FIG. 8 (d), a thread 72 is present in the second cooling connector 4 and not in the first cooling connector 3.

In the alternative shown in FIG. 8 (f), the mounting means 7 fixes the connecting area 81 of the object 8 as well as the first cooling connector 3 and the second cooling connector 4 by means of a thread 72 in the second cooling connector 4. FIG. 8 (g) shows a similar construction, but here, unlike in FIG. 8 (f), a thread 72 is present in the connecting area 81 of the object 8 and not in the second cooling connector 4.

In the alternative shown in FIG. 8 (h), the mounting means 7 fixes the mounting plate 9 as well as the first cooling connector 3 and the second cooling connector 4 by means of a thread 72 in the first cooling connector 3. FIG. 8 (i) shows a similar construction, but here, unlike in FIG. 8 (h), a thread 72 is present in the mounting plate 9 and not in the second cooling connector 4.

### LIST OF REFERENCE SYMBOLS

1 cooling device
2 cooling element
20 opening of the cooling element
3 first cooling connector
30 chamfered surface
4 second cooling connector
40 connecting part
41 trunnion
42 chamfered surface
43 opening
5 transfer element
6 sealing element
7 mounting means
70 force-fit through the mounting means
71 through-hole of the cooling connectors
72 thread
8 object
81 connecting area 81 of the object
9 mounting plate

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A cooling device for an object, the cooling device comprising:
a cooling element connectable to an object to be cooled;
a first cooling connector that is connected to the cooling element; and
a second cooling connector supportable on a mounting plate,
wherein the first cooling connector and the second cooling connector are configured to be connectable to transfer a cooling fluid from the first cooling connector to the second cooling connector.

2. The cooling device as set forth in claim 1, wherein the first cooling connector and the second cooling connector are configured to form a self-centering connection.

3. The cooling device as set forth in claim 1, wherein the first cooling connector and the second cooling connector are configured to compensate for at least one of a positional and an angular tolerance in the alignment of the first cooling connector with respect to the second cooling connector.

4. The cooling device as set forth in claim 1, wherein the object can be attached, via a form-fitting mounting means, to a mounting plate and the mounting means additionally fixes a connection between the first cooling connector and the second cooling connector.

5. The cooling device as set forth in claim 1, wherein the cooling element is connectable in at least one of a cohesive and form-fitting manner to the object to be cooled.

6. The cooling device as set forth in claim 1, further comprising a sealing element configured to seal a connection between the first cooling connector and the second cooling connector against leakage of the cooling fluid.

7. The cooling device as set forth in claim 1, wherein the second cooling connector is connectable with at least two first cooling connectors.

8. The cooling device as set forth in claim 7, wherein the second cooling connector is connectable with at least one of a line system, a distribution system and a collection system.

9. The cooling device as set forth in claim 1, wherein the second cooling connector is embodied in a single part.

10. The cooling device as set forth in claim 8, wherein the second cooling connector is embodied in a single part.

11. The cooling device as set forth in claim 1, wherein the second cooling connector comprises:
at least two connecting parts configured to connect to the first cooling connectors, and
at least one transfer element configured to transfer the cooling fluid between the at least two connecting parts.

12. The cooling device as set forth in claim 8, wherein the second cooling connector comprises:
at least two connecting parts configured to connect to the first cooling connectors, and
at least one transfer element configured to transfer the cooling fluid between the at least two connecting parts.

13. The cooling device as set forth in claim 1, wherein the first cooling connector has a surface that is chamfered toward at least one of the mounting plate and the cooling element, and wherein the second cooling connector has a surface that is chamfered toward the cooling element, wherein each chamfered surface of the first cooling connector and second cooling connector has an opening through which the cooling fluid is transferable from the first cooling connector to the second cooling connector.

14. The cooling device as set forth in claim 1, wherein the second cooling connector is a holder configured to receive the first cooling connector.

15. The cooling device as set forth in claim 1, wherein the first cooling connector has an opening and the second cooling connector has a trunnion, wherein the trunnion is insertable into the opening to transfer the cooling fluid from the first cooling connector to the second cooling connector via the trunnion and the opening.

16. The cooling device of claim 1, wherein the object is an energy store.

17. An automobile having a cooling device for an energy store to be cooled, the cooling device comprising:
a cooling element connectable to the energy store to be cooled;
a first cooling connector that is connected to the cooling element; and
a second cooling connector supportable on a mounting plate,
wherein the first cooling connector and the second cooling connector are configured to be connectable to transfer a cooling fluid from the first cooling connector to the second cooling connector.
